(19) United States
(12) Patent Application Publication
(10) Pub. No.: US 2024/0201384 A1
(43) Pub. Date: Jun. 20, 2024

(54) RADIOLOGICAL SURVEY SYSTEM

(71) Applicants: Kevin Banks, Tucson, AZ (US); Yugansh Bansal, Rohnert Park, CA (US)

(72) Inventors: Kevin Banks, Tucson, AZ (US); Yugansh Bansal, Rohnert Park, CA (US)

(73) Assignee: NAC Philotechnics, Ltd., Oak Ridge, TN (US)

(21) Appl. No.: 18/543,263

(22) Filed: Dec. 18, 2023

Related U.S. Application Data
(60) Provisional application No. 63/433,193, filed on Dec. 16, 2022.

(51) Int. Cl. G01S 17/894; G01S 7/51; G01S 17/87

(52) U.S. Cl. CPC G01S 17/894; G01S 7/51; G01S 17/87

(57) ABSTRACT

Systems and methods for mapping radiation within an area under test, including the provision of real-time visualization and reporting of localization of radiation levels and patterns on a map of the area under test, enabling efficient, timely, and accurate visualization and reporting of multi-dimensional localization of radiation levels within an area under test. A mobile vehicle is configured to support a radiation detector, a LIDAR sensor, a camera unit, and a processing unit enabling the mobile vehicle to traverse the area under test along one or more pathways as the radiation detector, LIDAR sensor, and camera unit are respectively generating radiation data, spacial coordinate data, and visualization data in real time.

### CROSS-REFERENCE TO RELATED APPLICATIONS

This application claims the benefit of U.S. Provisional Patent Application No. 63/433,193, filed Dec. 16, 2022, the contents of which are incorporated herein by reference in their entirety.

### BACKGROUND

### 1. Field of Invention

The present general inventive concept relates to a radiological survey system. More particularly, the present general inventive concept relates to an automated multi-dimensional radiation detection and measurement system for real-time radiological surveying of areas to determine locations of radiation levels and contamination in industrial or other environments.

### 2. Description of the Related Art

Radiological surveying-defined as monitoring an area for radiological contamination—is required under certain sets of conditions surrounding the production, use, storage, or existence of radioactive materials. The evaluation of the radiation hazards generally includes a physical survey of measurements and, from the physical survey data, the extrapolation of estimates of the levels of radiation involved. The physical survey includes steps of manually collecting data with respect to radiation levels. The physical survey includes collection of radiation data by radiological technicians and is prone to multiple errors. Multiple factors-including manual data entries, irregular survey areas, environmental factors, huge areas of radiological interest, and simple operator error-cause inefficiencies in the surveys and consequently in final reports resulting from those surveys. These inefficiencies lead to multiple site visits, project delays, and waste of project funds.

For example, U.S. Pat. No. 8,489,176, issued to Ben-David et al., discloses a system for calculating a position of a radioactivity emitting source in a system-of-coordinates, the system comprising (a) a radioactive emission detector; (b) a position tracking system being connected to and/or communicating with the radioactive emission detector; and (c) a data processor being designed and configured for receiving data inputs from the position tracking system and from the radioactive emission detector and for calculating the position of the radioactivity emitting source in the system-of-coordinates.

U.S. Pat. No. 9,012,843, issued to Joung, discloses a hand-held portable radiation detection device, such as a radiation isotopic identification device (RIID), that is integrated with a personal digital assistant device (PDA), such as a smart phone, to provide with improved data processing capability and user interface. The PDA is configured to receive and process data received from the radiation detection device.

U.S. Pat. No. 10,733,330, issued to Dubart and Morichi, discloses a method for modeling an environment with a risk of nuclear contamination comprising steps of: acquiring, using a detector (10) and through a 3-dimensional displacement of the detector in the environment, information related to the topography of the environment and radiological measurement data of the environment, and then via a computer processing unit (20), associating the radiological measurement data with location data in the environment, the location data having been deduced from path data of the detector, incrementally creating, using the information and via the computer processing unit: at least one matrix in which topographic data of the environment and the radiological data associated with the location data are compiled, and a 3-dimensional mapping representing the environment in which the topographic data and the radiological data are jointly represented.

U.S. Patent Application Publication No. 2010/0006763, by Lentering and Ruhnau, discloses a detector module for measuring one or more types of radiation, in particular X-ray, gamma ray, or nuclear particle radiation, comprising a detection unit, an analog-to-digital converter, an information processing device, and a memory device for storing the position of the detector module. The detector module comprises at least one light-emitting diode (LED), optically connected with the detection unit for stabilizing the detector unit. Further, the invention provides a stanchion, in particular a portable stanchion, whereby the stanchion comprises an inventive detector module. Yet further, a (wireless) network of detector modules is provided, whereby each detector module is mounted within a stanchion.

Because of manual data entries, irregular survey areas, large areas of radiological interest, and other environmental factors, known survey systems are less than satisfactory and very time consuming due to inefficiencies in the surveys and the final reports, leading to multiple site visits, delays in project timelines, and wastage of project funds.

### BRIEF SUMMARY

Example embodiments of the present general inventive concept provide systems and methods for mapping radiation within a bounded space, systems include advanced nuclear quality radiological survey systems (ANQR™), including real-time visualization and localization of radiation patterns on a boundary map of an area under test, enabling efficient, timely, and accurate visualization or reporting of multi-dimensional localization of radiation levels within an area under test. Example embodiments provide smart and automated hardware and software solutions configured to provide high levels of accuracy in a timely manner, allowing surveys to be completed relevantly much faster with minimal number of technicians involvement on a single project

Example embodiments of the present general inventive concept provide a multi-directional radiation detection, measurement, and mapping system configured to generate real-time visualization and graphical representations of radiation patterns and radiation intensities within a coordinate system of the bounded space, such as a room.

In some example embodiments, the system includes a radiation instrument configured to collect radiation identity data and radiation intensity data, including a light detection and ranging (LIDAR) sensor with two-dimensional simultaneous localization and mapping capabilities adapted to generate spatial coordinate data within a two-dimensional coordinate system within an area under test (which may be a bounded space such as a room), a camera unit configured to visualize objects and surfaces within a 3-dimensionsl bounded space and to generate three-dimensional visualization data of the area under test. The system includes a processing unit in communication with the radiation detector, the LIDAR sensor, and the camera unit, where the processor is configured to receive radiation identity data, radiation intensity data, spatial coordinate data, and three-dimensional visualization data. The processor can include processing modules configured to receive data from the radiation detector, LIDAR sensor, and camera unit, and to combine the radiation identity data, radiation intensity data, spatial coordinate data, and three-dimensional visualization data to generate reports and visual representations identifying precise locations of radiation levels and contamination as the system traverses about the area under test along one or more pathways, or trajectories.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying figures, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying figures in which:

FIG. 1 is a perspective view of an assembly according to one example embodiment of the present general inventive concept, showing a mobile pushcart vehicle supporting componentry of an exemplary radiological survey and mapping assembly;

FIG. 2 is a simplified block diagram of a system for mapping radiation within an area under test according to an example embodiment of the present general inventive concept;

FIG. 3 illustrates an example graphical representation configured in accordance with an example embodiment of the present general inventive concept, including a 2D trajectory map having visual pathways and locations of radiation levels of an area under test;

FIG. 4 illustrates an example graphical representation configured in accordance with an example embodiment of the present general inventive concept, including a 2D heat map of radiation intensities of an area under test; and

FIG. 5 illustrates the example graphical representation including a two-dimensional view as illustrated in FIG. 3 overlayed with a multi-dimensional image of the area under test according to an example embodiment of the present general inventive concept.

### DETAILED DESCRIPTION

Reference will now be made to the example embodiments of the present general inventive concept, examples of which are described below. The example embodiments are described herein in order to explain the present general inventive concept.

Example embodiments of the present general inventive concept provide a multi-directional radiation mapping system configured to generate real-time indications and visualization of radiation patterns and radiation intensities within a coordinate system of an area under test. The mapping system includes a radiation instrument, commonly referred to as a radiation detector or probe, adapted to collect radiation identity data and radiation intensity data from a given space. Example embodiments include a light detection and ranging (LIDAR) sensor configured to generate spatial coordinate data within a two-dimensional coordinate system, and a camera unit configured to visualize objects and surfaces within the area under test, thus providing three-dimensional data representing a visualization of the area under test. The system can include a processing unit configured to receive data from the radiation instrument, the LIDAR sensor, and the camera. The processing unit includes processing modules, or functions, configured to fuse, or combine, the radiation identity data, radiation intensity data, spatial coordinate data, and three-dimensional visualization data to generate reports and graphical representations of precise locations of radiation levels at various locations of the area under test. A mobile vehicle, such as a pushcart, robot, or other controlled device, can be configured to support and carry the radiation instrument, the LIDAR sensor, the camera, the processor, power source (e.g., battery), or other componentry to facilitate data collection as the vehicle traverses the area under test, for example along trajectories of pathways of movement within the area under test.

Some embodiments provide a multi-directional or multi-axial radiation mapping system configured to selectively generate real-time coordinates, visualizations, reports, and graphical representations of radiation patterns and radiation intensities within a coordinate system of a bounded space, such as a room, according to selections of a user on a touch screen or other user interface of the processing unit.

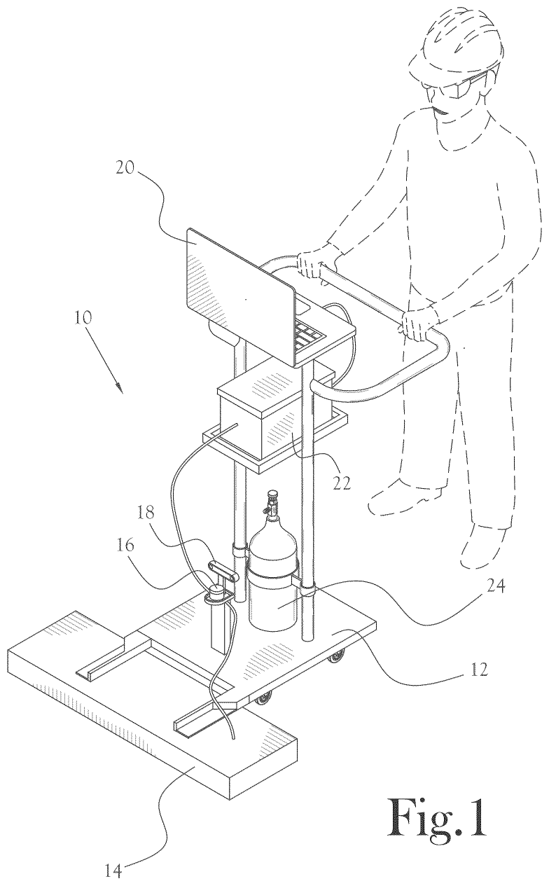

FIG. 1 illustrates a perspective view of a pushcart assembly according to one example embodiment of the present general inventive concept. As illustrated in FIG. 1, an assembly 10 for mapping radiation within a bounded space includes a pushcart 12 that holds a radiation instrument or probe 14 adapted to collect radiation measurements; a light detection and ranging (LIDAR) sensor 16 with two-dimensional simultaneous localization and mapping capabilities; and a camera 18 configured to visualize objects and surfaces within the bounded space. The radiation instrument 14, the LIDAR sensor 16, and the camera 18 are all in communication with a processor 20 (which, in the illustrated example embodiment and in various other example embodiments, takes the form of a laptop computer), which receives data from the radiation instrument 14, LIDAR sensor 16, and camera 18 and manipulates that data to generate reports. Generally, the assembly also includes a mobile power source 22 to supply electrical power to the other powered components on the pushcart 12 (including the radiation instrument 14, the LIDAR sensor 16, the camera 18, and the processor 20), as well as a gas canister 24 for supplying gas (such as a mixture of nitrogen and argon gases) to the radiation instrument 14 when such instrument 14 is a gas detector (or includes a gas detector).

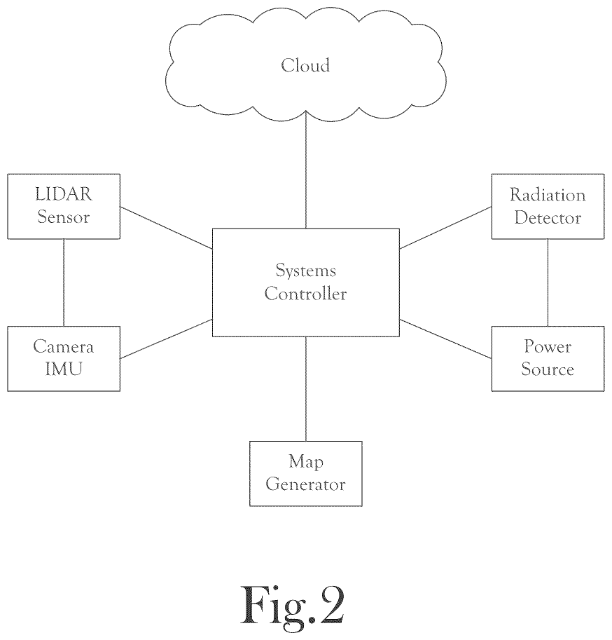

FIG. 2 illustrates, in simplified block diagram form, a similar example embodiment of the present general inventive concept as shown in FIG. 1. As shown in FIG. 2, an assembly 10a for mapping radiation within a bounded space includes radiation instrument or probe 14a; a LIDAR sensor 16a; and a camera 18a. The radiation instrument 14a, the LIDAR sensor 16a, and the camera 18a are all in communication with a processor 20a. Moreover, the assembly also includes a power source 22a to supply electrical power to the other powered components.

Generally speaking, then, a system for mapping radiation within a bounded space includes a radiation instrument adapted to collect radiation identity data and radiation intensity data; a LIDAR sensor with two-dimensional simultaneous localization and mapping capabilities adapted to generate spatial coordinate data within a two-dimensional coordinate system within the bounded space; and a camera configured to visualize objects and surfaces within a three-dimensional coordinate system within the bounded space, generating three-dimensional visualization data. Generally, the camera is equipped with an inertial measurement unit. A processor, in communication with the radiation instrument, the LIDAR sensor, and the camera, is configured to receive radiation identity data, radiation intensity data, spatial coordinate data, and three-dimensional visualization data; the processor runs a software program adapted to combine radiation identity data, radiation intensity data, spatial coordinate data, and three-dimensional visualization data to generate various reports and graphical representations. The assembly generally includes a vehicle adapted to support and carry all of the above components (along with a mobile power source to power those components that require electrical power). In some embodiments, the mobile vehicle is configured as a pushcart to be pushed by a user along pathways of the area under test, but various other types of vehicles could be used, manual or robotic. Here, the vehicle is configured to move along pathways of the area under test, collecting data from the components in real time. For example, the system generates, for each particular point or spacial coordinate, radiation data, including radiation identity data (from the radiation instrument), radiation intensity data (also from the radiation instrument), 2D spatial coordinate data within a two-dimensional coordinate system (from the LIDAR sensor), and three-dimensional visualization data within a three-dimensional coordinate system (from the camera). The processing unit is configured to receive, or collect this data and, via one or more processing modules, is configured to match, combine, and manipulate the data to generate various reports and visual representations, such as heat maps, 2D boundary maps, 3D visualizations of the bounded space with radiation patterns, and other reports formatted to meet regulatory requirements, all in as real time as possible.

FIG. 3 presents an illustration of one type of report generated by an example mapping system according to an example embodiment of the present general inventive concept, showing a 2D map of an area under test (a bounded room), illustrating a path 302 of an example pushcart through the bounded area 304. At regular points along the path 302, the example system collects radiation measurements from its radiation instrument or probe, spatial coordinate location data from the LIDAR sensor, and three-dimensional visualization data from the camera. As shown in FIG. 3, individual measurement points along the trajectory 302 are indicated by color-coded point markers, with green point markers 306, yellow point markers 307, and red point markers 308 indicating increasing levels of radioactivity. It will be appreciated that numerous variations, modifications, and additional embodiments of this basic setup are possible and are contemplated by the present general inventive concept, and that those variations, modifications, and additional embodiments fall within the scope of the present general inventive concept. For example, 2D trajectory maps as discussed herein are not limited only to point markers with a green-yellow-red color scheme; more than three colors can be used, and different colors can be used, according to the needs of the report's recipients and the nature of the bounded area being surveyed. It is also contemplated that some reports may be limited to showing one specific type of radioactivity, such as specifically alpha radiation, or specifically beta radiation, or specifically gamma radiation, or specifically X-ray radiation. Some reports may include and display data relating to multiple types of radiation, or to two or more selected types of radiation. A number of variations and modifications on the foregoing will be evident to those familiar with radiological surveying methods and technologies, and all such variations and modifications are also embraced by the scope of the present general inventive concept.

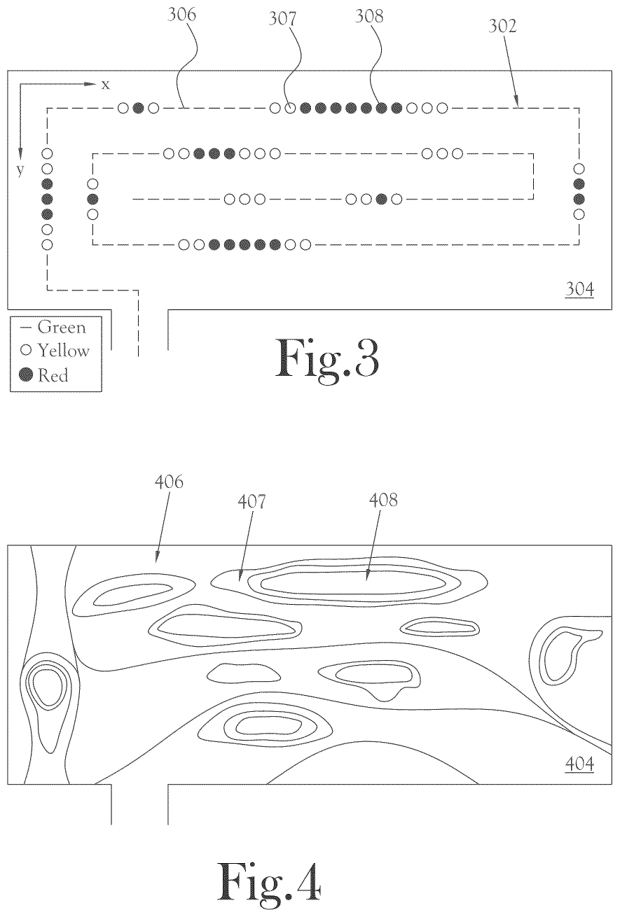

FIG. 4 is a view of another example report generated by an example embodiment mapping system as in FIG. 3, showing a 2D heat map of radiation intensities within an area under test 404. As in FIG. 3, so too here levels of radioactivity are color-coded, with green areas 406, yellow areas 407, and red areas 408 indicating increasing levels of radioactivity. It will be appreciated that numerous variations, modifications, and additional embodiments of this basic setup are possible and are contemplated by the present general inventive concept, and that those variations, modifications, and additional embodiments fall within the scope of the present general inventive concept. For example, radioactivity heat maps as discussed herein are not limited only to a green-yellow-red color scheme; more than three colors can be used, and different colors can be used, according to the needs of the report's recipients and the nature of the bounded area being surveyed. It is also contemplated that some reports may be limited to showing one specific type of radioactivity, such as specifically alpha radiation, or specifically beta radiation, or specifically gamma radiation, or specifically X-ray radiation. Some reports may include and display data relating to multiple types of radiation, or to two or more selected types of radiation. A number of variations and modifications on the foregoing will be evident to those familiar with radiological surveying methods and technologies, and all such variations and modifications are also embraced by the scope of the present general inventive concept.

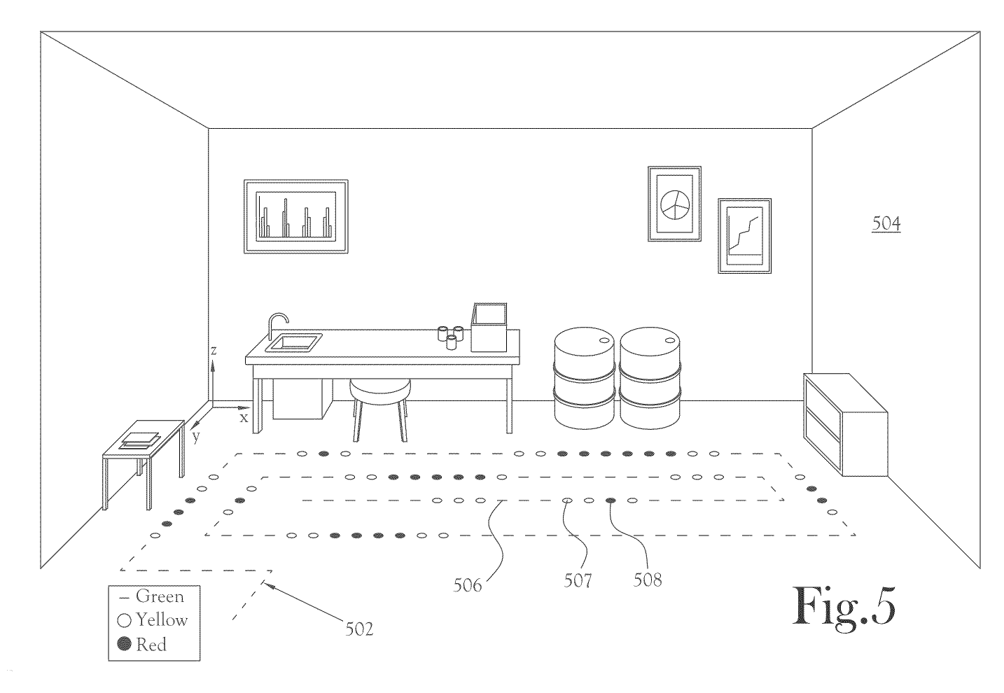

FIG. 5 is a view of a view of another example report generated by the same example embodiment mapping system as in FIGS. 3 and 4. As shown in FIG. 5, the example software program uses 3D visualization data from the camera to generate a 3D visualization of the area under test 504; the example software program further integrates that 3D visualization of the area 504 with an overlaid trajectory map indicating radiation localizations and radiation intensities within the bounded space. As with the 2D trajectory map shown in FIG. 3, so here too green point markers 506, yellow point markers 507, and red point markers 508 indicate escalating intensities of radiation readings at selected points along the path 502 of the pushcart within the bounded space 504. The end result is a 3D visualization of the bounded space with trajectory map indicating radiation localizations and radiation intensities within the bounded space. A number of variations and modifications on the foregoing will be evident to those familiar with radiological surveying methods and technologies, and all such variations and modifications are also embraced by the scope of the present general inventive concept.

In various example embodiments, the software program running on the processor automates the creation of CSV files containing X/Y/Z coordinates, radiation data, and statistical metrics like standard deviation. These raw data files are vital for generating comprehensive reports. The software generates boundary map images that overlay radiation spots onto the map, providing a clear visual representation of radiation distribution in both real time and as an output image.

Various example embodiments of the present general inventive concept provide systems and processes for mapping radiation within a bounded space, supplying real-time visualization and localization of radiation patterns on a boundary map and enabling multi-dimensional localization of radiation sources. Example systems according to example embodiments of the present general inventive concept offer the ability to conduct thorough radiation surveys within indoor spaces, ensuring the identification and characterization of radiation contamination across various surfaces and objects. By integrating Lidar and camera technologies, the system precisely localizes radiation sources within the surveyed area, enabling the accurate mapping of radiation intensity distribution. The system provides real-time visualization of radiation patterns through color-coded mapping, allowing immediate identification of radiation hotspots and trends.

In various aspects and applications, example mapping systems according to example embodiments of the present general inventive concept contribute to the safety assessment of decommissioned buildings by enabling a detailed examination of potential radiation contamination areas, ensuring a safe environment for workers and the public. Moreover, systems and processes discussed herein facilitate informed choices regarding decontamination strategies, demolition plans, and certification processes. By identifying and managing radiation contamination effectively, example mapping systems according to example embodiments of the present general inventive concept contribute to safeguarding the environment and minimizing potential health risks associated with radiation exposure.

Thus, according to some example embodiments of the present general inventive concept, a system for mapping radiation within a bounded space includes a radiation instrument adapted to collect radiation identity data and radiation intensity data, a light detection and ranging (LIDAR) sensor with two-dimensional simultaneous localization and mapping capabilities adapted to generate spatial coordinate data within a two-dimensional coordinate system within the bounded space, a camera configured to visualize objects and surfaces within a three-dimensional coordinate system within the bounded space, generating three-dimensional visualization data, a processor in communication with the radiation instrument, the LIDAR sensor, and the camera, the processor configured to receive radiation identity data, radiation intensity data, spatial coordinate data, and three-dimensional visualization data, the processor running a software program, the software program adapted to combine radiation identity data, radiation intensity data, spatial coordinate data, and three-dimensional visualization data to generate reports, and a vehicle adapted to hold the radiation instrument, the LIDAR sensor, the camera, and the processor, the vehicle adapted to move about the bounded space along a trajectory.

In some embodiments, the vehicle is a pushcart. In some embodiments, the reports generated by said software program include real-time visualization of radiation patterns and radiation intensities within a coordinate system of the bounded space. In some embodiments, the reports include a color-coded radiation map. In some embodiments, the reports include a boundary map. In some embodiments, the reports include a trajectory map. In some embodiments, the radiation instrument adapted to collect radiation identity data and radiation intensity data is configured to detect alpha radiation, beta radiation, or gamma radiation. In some embodiments, the radiation instrument is adapted to collect radiation identity data and radiation intensity data, such as alpha radiation, beta radiation, and gamma radiation in counts per second (cps), and consolidate the radiation data within a three dimensional coordinate system and stream real-time location based on beacons and/or a LIDAR sensor, thus minimizing risk of leaving areas un-surveyed during the survey process.

Referring to the figures, the processor can include a display unit, such as an LCD, configured to output graphical representations of reports for visualization by users. The display can be an LCD Touch display configured for user interface. The display unit can include a large touch display with various user settings, such as for accommodating various voltage/power environments, different radiation parameters, contamination levels, and measurement modes for various applications and environments.

In some embodiments, WiFi functionality can be provided for uploading log files to a backend server, and custom client-based phone application support can be configured for downloading and viewing generated reports in real time. Bluetooth functions can be provided for smart device connection and application interface. For example, embodiments can provide a gateway between the survey unit and the backend server where the automated reports can be accessed by the client instantly and the generated maps can also be viewed via client based custom application while the survey is in progress.

GPS receivers with GLONASS, Galileo, Bei Dou with 10 mm position accuracy can be implemented for use in both indoor and outdoor environments. For example, in addition to LIDAR sensors, a stream of real time location data can be based on high precision GPS receivers in outdoor environments or stationary ultrasonic beacons in indoor environments. The example systems can be configured to make all the functionalities accessible to a user via a single mobile hardware device connectable to any PC, Smart phone or Tablet for data review, modification, downloads, visualizations, or report filings configured to meet regulatory requirements.

Further, according to some example embodiments of the present general inventive concept, a process for multi-dimensional real-time visualization of radiation patterns within a coordinate system of a bounded space includes providing a vehicle holding a radiation instrument adapted to collect radiation identity data and radiation intensity data, a light detection and ranging (LIDAR) sensor with two-dimensional simultaneous localization and mapping capabilities adapted to generate spatial coordinate data within a two-dimensional coordinate system within the bounded space, a camera configured to visualize objects and surfaces within a three-dimensional coordinate system within the bounded space, generating three-dimensional visualization data, and a processor in communication with the radiation instrument, the LIDAR sensor, and the camera, the processor configured to receive radiation identity data, radiation intensity data, spatial coordinate data, and three-dimensional visualization data, the processor running a software program, the software program adapted to manipulate radiation identity data, radiation intensity data, spatial coordinate data, and three-dimensional visualization data to generate reports; moving the vehicle about the bounded space along a trajectory, collecting radiation identity data, radiation intensity data, spatial coordinate data, and three-dimensional visualization data at several locations along said trajectory within the bounded space; and integrating radiation identity data, radiation intensity data, spatial coordinate data, and three-dimensional visualization data for several locations within the bounded space to generate a report that includes a boundary map representing radiation patterns within the bounded space.

In some embodiments, the reports include a color-coded radiation map. In some embodiments, the reports include a boundary map. In some embodiments, the reports include a trajectory map. In some embodiments, the radiation instrument adapted to collect radiation identity data and radiation intensity data is configured to detect alpha radiation, beta radiation, or gamma radiation. In some embodiments, the vehicle is a pushcart.

Example embodiments of the present general inventive concept can be achieved by systems and methods configured to map radiation levels within an area under test, and to provide real-time visualization and localization of radiation patterns on a boundary map and enabling multi-dimensional localization of radiation sources, thus reducing the human effort involved in performing radiological surveys. The example systems can be configured to consolidate radiation data with the three dimensional coordinate system and determines precise location of radiation level and contamination, generating graphs and reports by geo-referencing these locations. For example, the processing modules can be configured to match the two-dimensional data received from a LIDAR sensor to radiation levels detected by the radiation probe at corresponding X-Y coordinates, thus fusing location data to radiation counts at precise locations. Moreover, the processing modules can be configured to overlay X-Y data of the LIDAR sensor with corresponding X-Y-Z data of the camera to enhance visualization of locations of the area under test highlighted with graphical representations (e.g., green, yellow, red lines) of radiation levels of the area under test overlayed on a 3-D map or image of the area.

Some embodiments of the present general inventive concept can be achieved by a process for multi-dimensional real-time visualization of radiation patterns within a coordinate system of a bounded space, including providing a mobile vehicle, such as a push cart, robot device, or other mobile vehicle to support a radiation instrument thereon to collect radiation identity data and radiation intensity data as the vehicle traverses an area under test, such as a room. The system can include a light detection and ranging (LIDAR) sensor with two-dimensional simultaneous localization and mapping capabilities adapted to generate spatial coordinate data within a two-dimensional coordinate system within the bounded space, a camera configured to visualize objects and surfaces within a three-dimensional coordinate system within the bounded space, generating three-dimensional visualization data, and a processor in communication with the radiation instrument, the LIDAR sensor, and the camera, the processor configured to receive radiation identity data, radiation intensity data, spatial coordinate data, and three-dimensional visualization data, the processor running a software program, the software program adapted to manipulate radiation identity data, radiation intensity data, spatial coordinate data, and three-dimensional visualization data to generate reports; moving the vehicle about the bounded space along a trajectory, collecting radiation identity data, radiation intensity data, spatial coordinate data, and three-dimensional visualization data at several locations along said trajectory within the bounded space; and integrating radiation identity data, radiation intensity data, spatial coordinate data, and three-dimensional visualization data for several locations within the bounded space to generate a report that includes a boundary map representing radiation patterns within the bounded space.

The integration of LIDAR and camera technologies enables multi-dimensional localization of radiation sources. By seamlessly fusing data from Lidar scans, camera depth perception, and radiation instrument readings, example embodiments of the present general inventive concept provide a more nuanced understanding of radiation distribution and its correlation with spatial features. Precise positioning enhances mapping accuracy and provides a deeper understanding of radiation distribution. Unlike conventional methods that rely on post-processing, example embodiments of the present general inventive concept provide real-time visualization of radiation patterns on a boundary map. This immediate feedback allows for on-the-fly decision-making and quicker identification of contamination areas. The example system's trajectory tracking feature displays the movement path of the system within the environment. Dynamic representation offers a comprehensive overview of radiation levels, aiding in pinpointing radiation sources. Moreover, these systems automate the creation of detailed reports containing raw data, spatial coordinates, radiation levels, and statistical metrics; this automated process reduces manual effort and helps to protect data integrity.

Further, example embodiments of the present general inventive concept offer real-time views of the maps that display live contamination levels along with its corresponding locations. These real-time reports help technicians with a live view of their survey areas that can mitigate un-surveyed areas. In various embodiments, these example systems also offer live updates of the surveys and reports by uploading files on a backend server and sending reports to clients via a custom application built exclusively for those clients. The clients can view surveyed map areas and other reports immediately. Example embodiments of the present general inventive concept can provide live notifications to users or technicians indicating when the surveys start and end, establishing confidence and trust of the surveying process.

As described herein, it is understood that the system, apparatus, methods, processes, functions, and/or operations for implementing embodiments of the invention may be wholly or partially implemented in the form of a set of instructions executed by one or more programmed computer processors such as a central processing unit (CPU) or microprocessor. Such processors may be incorporated in the circuitry and components of an apparatus, server, client or other computing or data processing device operated by, or in communication with, other components of the system.

Example embodiments of the present general inventive concept may be embodied in whole or in part as a system, as one or more methods, or as one or more devices. Embodiments of the invention may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, controller, etc.) that is part of a client device, server, network element, or other form of computing or data processing device/platform. The processing element or elements can be programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array (PGA or FPGA), application specific integrated circuit (ASIC), or other known or later developed circuitry and the like, specifically configured and arranged to generate signals instructing the various components to carry out the data processing functions.

As described herein, the systems, apparatus, methods, processes, functions, and/or operations for implementing the example embodiments of the present general inventive concept may be wholly or partially implemented in the form of apparatus that includes processing elements and sets of executable instructions. The executable instructions may be part of one or more software applications and arranged into software architecture. In general, embodiments of the present general inventive concept may be implemented using a set of software instructions that are designed to be executed by a suitably programmed processing element (such as a CPU, GPU (graphics processing unit), microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application models may include any suitable computer executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. The computer-executable code or set of instructions may be stored in (or on) any suitable non-transitory computer-readable medium. In general, with regards to the embodiments described herein, a non-transitory computer-readable medium may include almost any structure, technology or method apart from a transitory waveform or similar medium.

As described, the systems, apparatus, methods, processes, functions, software and/or operations for implementing the example embodiments of the present general inventive concept may be wholly or partially implemented in the form of a set of instructions executed by one or more programmed computer processors such as a central processing unit (CPU) or microprocessor. Such processors may be incorporated in the circuitry and components of an apparatus, server, client or other computing or data processing device operated by, or in communication with, other components of the system.

It is understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes, models, or functions described in this application may be implemented as software code to be executed by a processor using any suitable computer language such as, for example, Java, JavaScript, C++ or Perl using, for example, conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus, and may be present on or within different computational apparatuses within a system or network.

According to some example implementations, the term processing unit or processor, as used herein, may be a central processing unit (CPU), or conceptualized as a CPU (such as a virtual machine). In such example implementation, the CPU or a device in which the CPU is incorporated may be coupled, connected, and/or in communication with one or more peripheral devices such as a cell phone, cloud-based application, or other known communication devices, as well as one or more displays, or output units. In other example implementations, the processing unit or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to configurations, functions, processes, or methods. It will be understood that one or more of the configurations, methods, processes, and functions can be implemented by computer-executable program instructions. Note that in some embodiments, one or more of the configurations, methods, processes, systems, and functions may not necessarily need to be performed in a particular order, or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, systems, or methods described herein.

These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A radiological survey system, comprising:
a radiation detector configured to collect radiation data of an area under test;
a light detection and ranging (LIDAR) sensor configured to generate spatial coordinate data of the area under test;
a camera unit configured to generate three-dimensional visualization data of the area under test;
a processing unit configured to receive the radiation data, the spacial coordinate data, and the visualization data in real time, the processing unit including one or more modules configured to match the spacial coordinate data to the radiation data and generate location data of radiation levels within the area under test;
a mobile vehicle configured to support the radiation detector, the LIDAR sensor, the camera unit, and the processing unit, the mobile vehicle being configured to traverse the area under test along one or more pathways of within the area under test as the radiation detector, LIDAR sensor, and camera unit are respectively generating radiation data, spacial coordinate data, and visualization data in real time; and
a display unit configured to output one or more graphical representations showing the location data of radiation levels within the area under test.

2. The system of claim 1, wherein the one or more processing modules are configured to match the three-dimensional visualization data to the spacial coordinate data, and the display unit is configured to output a graphical representation comprising a three-dimensional image of the area under test together with the location data of radiation levels.

3. The system of claim 1, wherein the display unit is configured to generate the graphical representations in real time as the mobile vehicle is traversing the area under test, including real-time visualization of radiation patterns and radiation intensities within a coordinate system of the area under test.

4. The system of claim 1, wherein the radiation detector is configured to detect and collect radiation identity data and radiation intensity data of one or more of alpha radiation, beta radiation, or gamma radiation.

5. The system of claim 1, wherein the one or more processing modules are configured to match two-dimensional data received from the LIDAR sensor to radiation levels of the radiation data received from the radiation detector, and the display unit is configured to generate a graphical representation of radiation levels along pathways of the area under test in real time as the mobile vehicle is traversing the area under test.

6. The system of claim 1, wherein the one or more processing modules are configured to match X-Y data received from the LIDAR sensor with X-Y-Z data received from the camera unit, and the display unit is configured to generate a graphical representation of radiation levels along pathways of the area under test together with a three-dimensional image of the area under test in real time as the mobile vehicle is traversing the area under test.
